(19) United States
(12) Patent Application Publication
(10) Pub. No.: US 2015/0339740 A1
(43) Pub. Date: Nov. 26, 2015

(54) Bill Calculation and Payment System

(71) Applicant: Charles Alexander Sherman, Los Angeles, CA (US)

(72) Inventor: Charles Alexander Sherman, Los Angeles, CA (US)

(21) Appl. No.: 14/695,976

(22) Filed: Apr. 24, 2015

Related U.S. Application Data
(60) Provisional application No. 61/984,183, filed on Apr. 25, 2014.

(51) Int. Cl. G06Q 30/04; G06Q 50/12; G06Q 20/40; G06Q 20/14; G06Q 20/34

(52) U.S. Cl. CPC G06Q 30/04; G06Q 20/14; G06Q 20/3567; G06Q 20/409; G06Q 50/12

(57) ABSTRACT

A network of computer tablets connected to a central router and an existing Point of Sales system. An Attachment affixed to each tablet and in electronic communication with the tablet allows customers to pay bills by, for example, swiping credit cards, and use coupons by, for example, scanning coupon bar codes. An Application interface installed on each tablet presents an itemized bill and offers choices for allocating portions of the bill amongst multiple payers. The Application interface also facilitates bill payment, coupon redemption, and receipt delivery. A Database in communication with the router aggregates customer information that can be used to distribute targeted coupons.

### FIELD OF THE INVENTION

The present invention relates generally to bill payment systems. More specifically, the present invention relates to bill payment systems that allow efficient calculation and payment of bills at restaurants and other hospitality establishments.

### BACKGROUND INFORMATION

The process by which restaurants and other hospitality establishments make their customers pay their bills is typically inefficient, slow and cumbersome. In every other way, restaurants try to provide quick and efficient table service. But when it comes time for customers to settle up the bills, the entire process slows down substantially and creates bottlenecks in the turnover of tables and causes frustration for busy customers who want to get on with their day. The basic problems lie with the time it takes for the serving staff to repeatedly go back and forth between the tables and the restaurant's Point of Sales (POS) systems, as customers try to calculate their shares of the bill, calculate their tip amounts, and redeem any coupons they have. In cases where multiple payers are splitting the bill, there is added complexity and time involved to divide up and calculate each person's share. The final, and maybe the biggest, issue is the complication and time it takes for the waiting staff to process multiple credit/debit card and cash payments for a single bill with multiple payers.

Although reference is made herein to the inventions in the context of restaurants, the inventions are equally applicable to hotels, standalone bars, and other hospitality-based establishments.

### SUMMARY OF THE INVENTION

The System is a network of computer tablets, the number of which depends on the size and requirements of individual restaurants. The tablets are wirelessly connected to a central wireless router, the Router. The Router is physically and/or wirelessly connected to the restaurant's existing Point of Sales (POS) system. A slim physical attachment, the Attachment, may be affixed along the upper length of each tablet, or may sit alongside each tablet with the aid of a tablet cover to work as a single payment unit. Each Attachment may also have a connecting arm that plugs directly into the tablet's docking port, allowing the Attachment and tablet to electronically communicate with each other. Each tablet may be pre-installed with an application, the Application, that is an interface between the paying customers, the System, the restaurant's existing POS and any standalone payment systems the restaurant might have.

The Attachment may have a slot along its upper edge that payers can use to swipe their credit, debit and pre-paid gift cards (referred to collectively in this document as cards). Inside the slot is a card reader that reads these cards and a processor that wirelessly sends and receives the cards' authorization data to the restaurant's existing card payment systems. The Attachment may also have an in-built barcode scanner to process any coupons the restaurant has distributed. It may transmit the data for verification and then relay the verified information to the Application for bill recalculation.

Every tablet may have the Application pre-installed. The Application makes the process of paying the bill simple and easy. When a table requests its bill, the waitperson may wirelessly download the table's itemized bill information from the restaurant's POS system onto an available tablet and leave it with the table. The customers at the table can see their itemized bill breakdown and the total amount due. The Application also presents the table with 3 options: a) pay the entire amount with one payment, b) split the bill evenly amongst a designated number of payers, or c) split the bill according to what the designated payers specifically ordered. Once one of these options is selected, the Application divides the bill accordingly before the Application helps individual payers set their own tips. If any coupons are redeemed, it then recalculates each payer's total amount due. The Application may ask each payer whether they want to pay by credit/debit card. If a payer chooses to pay by credit/debit card, the Application may automatically inform the Attachment how much to charge the next card to be swiped. Once the Application receives authorization for or rejection of the credit/debit card, it informs the payer.

The Application may provide the payer with two receipt and card authorization choices: a hard copy receipt, or an e-mail with an electronic receipt sent to the payer's designated e-mail address. If the payer opts for the e-mailed receipt, the payer's e-mail address and itemized share of the bill is wirelessly sent to a central or cloud-based Database connected to the System. The Database then e-mails the specific receipt to the specific payer. The Database also aggregates the customer information and can be used and analyzed by the restaurant to distribute targeted e-mail based coupons. A simple web portal linked to the Database allows customers to access their own receipts on the Database by entering the receipts' unique codes. This is useful for tax and accounting purposes when receipt verification is needed.

The Router may be a wireless router that connects the tablets to the restaurants' Point of Sales Systems, and any standalone credit and debit card payment systems and coupon systems they may already use. It also connects to the offsite central Database.

### BRIEF DESCRIPTION OF THE DRAWINGS

FIG. 1 is an angled view of an exemplary Attachment.

FIG. 2 is a front view of an exemplary Attachment attached to a tablet with internal components shaded.

FIG. 3 is an angled view of an exemplary Attachment attached to a tablet.

FIG. 4 is a right and left side perspectives of an exemplary Attachment attached to a tablet.

FIG. 5 is an exemplary representation of the Application's Server Screen.

FIG. 6 is an exemplary representation of the Application's Options Screen.

FIG. 7 is an exemplary representation of the Application's Allocation Screen.

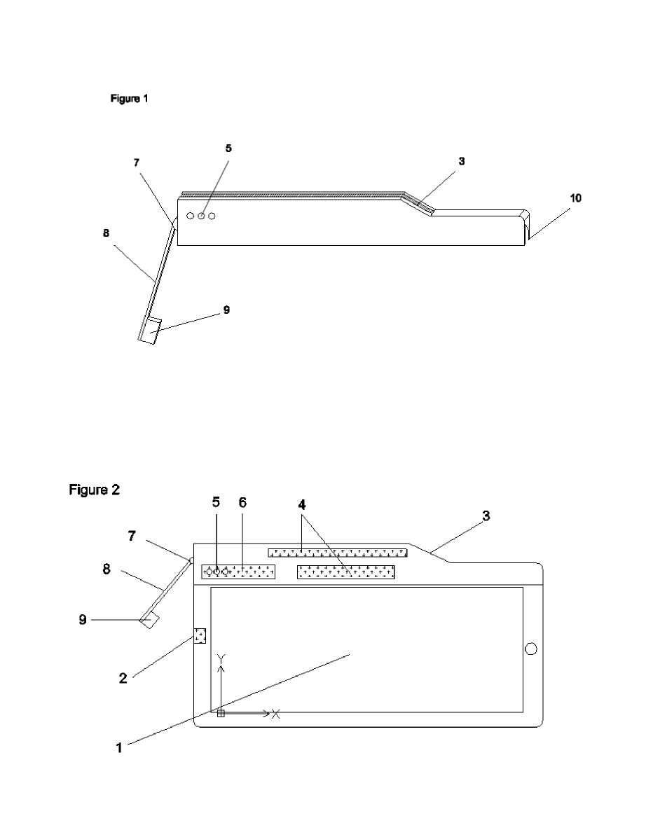

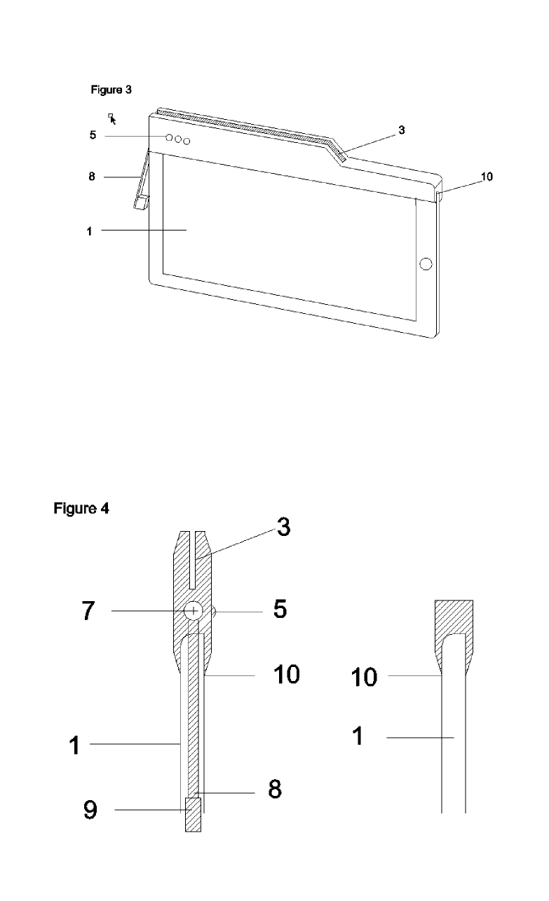

### DETAILED DESCRIPTION

The preferred embodiment of the System consists of 4 parts: an Attachment, an Application, a Router and a Database. These components interact and communicate with each other. The design and function of each of those parts will be described separately. Also described is how they operate and interact together as the System.

(1) The Attachment

The numbers in parentheses used in the following description refer to the drawings. As shown in FIG. 1, the Attachment may be a molded strip designed to fit along the upper edge of a computer tablet (1). It is preferably made from either plastic, composite, rubber or some combination of these materials. The Attachment may be affixed to the tablet by slotting the upper edge of the tablet into a groove (10) situated inside the rubberized bottom edge of the Attachment to create a natural tight fit. The Attachment can also be kept in place, without physically attaching it to a tablet, by using a tablet cover to hold the tablet and the Attachment in place.

Along the topside of the Attachment may be another groove spanning a portion of its length (3) through which payers swipe their debit, credit and gift cards. On the flat, forward-facing side of the Attachment may be a barcode reader with which customers can scan relevant coupons with barcodes (5). At one end of the Attachment may be a hinged connector arm (8) with a USB or any other docking plug (9) that is compatible with the tablet's docking portal. The connector arm extends down to connect the Attachment to the tablet's portal (2).

The Attachment may be made out of plastic, rubber or composite material. It may be constructed from a single piece, or multiple pieces that snap together to form a single piece. Four main components may be built within the strip: a credit/debit card magnetic strip reader, a credit card reader processor & wireless transmitter/receiver, a barcode scanner, and a barcode processor & wireless transmitter/receiver. A thin plastic or rubber strip, the connector arm, may be attached to one side with a hinge (7). A USB or other tablet-specific docking plug (9) may be attached to the other end of the connector arm. Inside the connector arm are the wires to connect the Attachment and the tablet, allowing electronic communication between the two pieces of hardware. The connector arm may also provide the connection that allows the tablet to provide any power the Attachment needs to operate.

The card reader may be embedded within the walls of the Attachment upper groove that customers swipe their credit, debit and gift cards through (3). The reader may be connected to the card processor and transmitter (4) also situated within the Attachment. The card processor is wired through the connector arm to the USB or other docking plug.

The barcode scanner (5) may be positioned facing out from the front face of the Attachment. Inside the strip, the barcode scanner may be connected to barcode processor and transmitter/receiver (6). The processor may also be wired through the connector arm to the USB or other docking plug.

The Attachment connects to a computer tablet to become a single portable payment unit. The Attachment, working with the other components that make up the System, has two main functions. First, it may read credit, debit and gift cards and send for and receive authorization directly to and from a Point of Sales system if said POS system is connected to a payment processing system or directly to and from a standalone payment processing system. Second, it may scan the barcodes on paper or electronic coupons and send for and receive coupon verification to and from a POS system or to and from a standalone coupon verification system.

When a table of customers have finished their meal and they ask their waitperson for the bill, the waitperson fetches the nearest available tablet with an attached Attachment and leaves it on the table. From this point on, the payment procedure is completely in the hands of the customers. Very little interaction with the wait staff is needed.

The Attachment's first main function may be to read customers' credit, debit cards and any pre-paid gift cards the specific restaurant or restaurant chain has issued. The paying customers may use the Application to establish the amounts they need to pay. If a payer chooses to pay with a credit or debit card, the Application informs the Attachment, via the connector arm, how much to charge the next card swiped through the slot. The payer, when prompted, swipes their card through the slot, the magnetic strip reader inside the Attachment reads the information, charges the amount assigned, and then sends this information off the restaurant's card payment processing system for verification and authorization.

If the restaurant has a POS system with an in-built communication link to the existing card payment processing system it uses, when a credit or debit card is swiped through, its information and the amount charged may be sent wirelessly to the modem. The modem relays the information to the POS system which in turn contacts its payment processing system for verification and authorization. The POS system then relays it back to the modem, the modem may wirelessly transmit the verification and authorization back either directly to the tablet or to the Attachment that then relays it to the Application installed on the tablet via the connector arm.

If the restaurant has a standalone card payment processing system, i.e. one that is not directly connected to its POS system, the Attachment may bypass the POS system completely. When a card is swiped, the Attachment may transmit the card information and the amount to be charged directly to the standalone system for verification and authorization. When the standalone system verifies, then authorizes or declines the card, it may relay the information directly back to the Attachment. The Attachment may then pass it on to the Application installed on the tablet and lets the payer know that their payment has been authorized or declined.

The System is also flexible enough to process other mobile payment options as well. Mobile payment methods do not require a direct connection to standard card payment processing systems, either via a POS system or any standalone system. Mobile payment systems connect directly with third party mobile payment companies directly over the Internet. Some restaurants, either by choice or for other reasons, may not have a traditional POS/card payment system and rely completely on mobile payment systems to charge customers' cards. In these cases, when a customer swipes their card through the Attachment, it may relay the card information and amount to be charged directly to the Application installed on the tablet, via the connector arm. The Application then just acts as any other mobile device and wirelessly sends the information to the third party mobile payment processor over the Internet for verification and authorization. The third party processing company then sends back authorization directly to the tablet's Application. This gives the System the capability to adopt any mobile payment system available now and in the future.

Coupon verification and redemption is the Attachment's second main function. If customers bring along valid paper or electronic coupons issued by the restaurant and want to redeem them, when prompted they may hold their coupon's barcode in front of the Attachment's in-built coupon scanner. The scanner reads the barcode and the in-built barcode processor may then convert it into a transmittable and applicable form. The processor then has various options depending on the restaurant's chosen coupon system.

If a restaurant's coupon system works within their existing POS system, then the barcode processor may wirelessly transmits the individual coupon's barcode data, via the modem, directly to the POS system. The POS system validates and logs the barcode, sends verification signal to the modem which may then wirelessly transmit barcode confirmation plus all deal information either back to the Attachment processor that then relays the deal discounting information, via the connector, to the Application which then may apply the appropriate discount to the bill total or directly to the tablet, where the Application applies the appropriate discount.

If the restaurant has a coupon system entirely separate from its POS system such as a web-based system then once a barcode is scanned, instead of wirelessly transmitting the coupon information to the POS, the processor may send the information directly to the tablet, via the connector arm. The tablet may then uses its own wireless (Wi-Fi) connection to access the web-based coupon system for verification and logging. The web-based coupon system may then returns all confirmation and deal information directly back to the tablet via its wireless connection. The Application may then apply the appropriate discount.

If the restaurant has no existing coupon system, POS or other coupon verification and Database software can be installed directly onto the individual tablets and updated as needed. In this scenario, the barcode reader may send information directly, via the connector arm, to the tablet. The software can then verify and log the coupon, and the Application may then apply the appropriate discount.

(2) The Application

The Application is the brains of the System. It is an application that can be built, for example, on the Android, Apple's IOS, Microsoft's Windows, or Linux platforms to be used on computer tablets and other personal communication devices. The Application is the user-friendly interface with the customer, controls the Attachment and interacts with a restaurant's existing Point of Sales (POS) system and/or card payment processing system.

The Application may wirelessly download the itemized bill from the restaurant's POS system to an assigned tablet and helps the designated payers calculate and allocate the bill amongst them. It may allow one payer to pay the entire bill in full, multiple payers to split the bill evenly, or multiple payers to allocate specific items on the bill to specific payers. The Application may also calculate tip amounts, apply coupon discounts, allow payers the option of either getting a paper or email-based receipts, and inform the Attachment how much to charge each credit or debit card, before it informs the payers that their payments are authorized or declined.

The design and function of the user interface is preferably simple, clean and intuitive. It may be based on boxes that can be moved, pinched together, dragged and dropped and expanded and contracted on the tablet's screen. These boxes may provide the foundation of the application's look and feel.

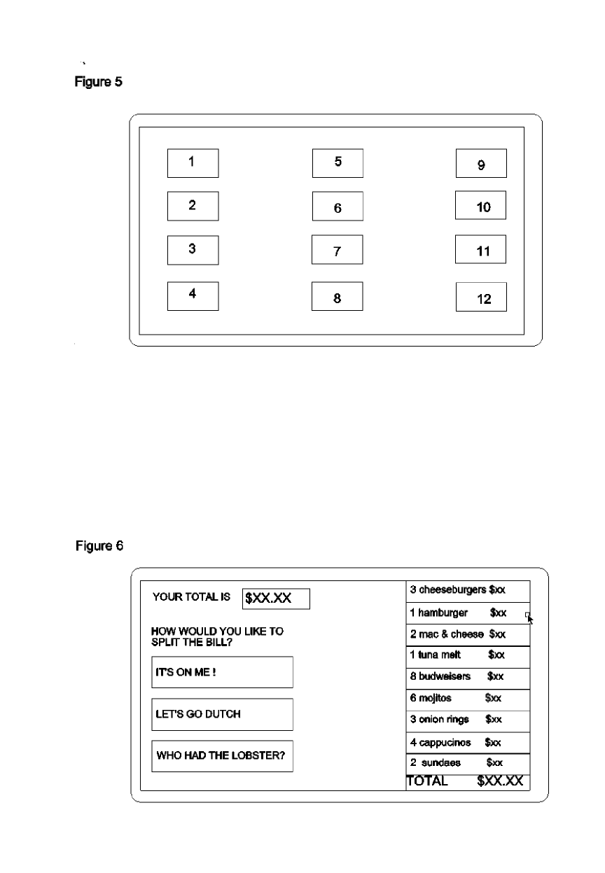

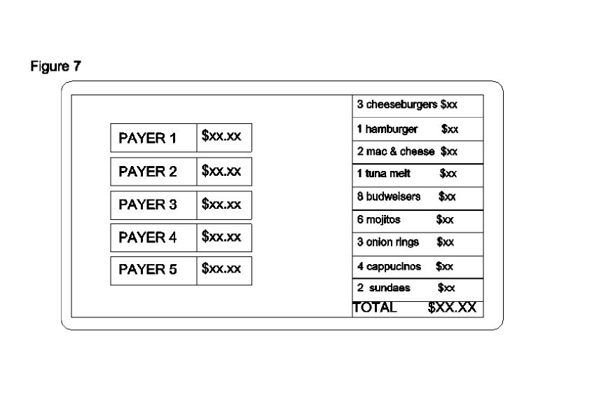

In one embodiment, to get through the payment process, each payer must progress their way through a series of screens. To get to the starting point, the waitperson may first download a specific table's bill off the POS system onto the designated tablet's Application. The screen to help the waitperson download the correct information is a bill-downloading screen also known as the Server Screen. When a table asks for its bill, the waitperson grabs the nearest available tablet and pulls up the Server Screen. This screen may display numbered boxes, each box representing one of the tables in the restaurant (see, e.g., FIG. 5). For example, Box 1 may represent Table 1 as assigned in the restaurant's existing POS system. If Table 1 wants to pay its bill, the waitperson may tap the Table 1 box and the Application on the tablet may wirelessly download the list of items Table 1 ordered and the amount due from the POS system. Once the itemized list is downloaded, an Options Screen may appear on the tablet (see, e.g., FIG. 6). The waitperson may leave the tablet with the table with an Allocation Screen displayed (see, e.g., FIG. 7). The customers at Table 1 then have to work their way through a series of screens to settle up their bill.

The first screen the customers encounter may be the Options Screen. The Options Screen may display a sidebar with a scrollable list of the items the table ordered and the total amount due. It may also display 3 payment options. Option 1 may allow a single payer to pay the entire bill, that can be named something such as the “It's On Me” option. Option 2 may allow multiple payers to split and pay the bill evenly, named something such as the “Let's Go Dutch” option. Option 3 may allow multiple payers to allocate each item on the bill to a specific payer i.e. they pay for what they order, named something such as the “Who Had The Lobster?” option. The table may decide how they want to split the bill.

In a preferred embodiment, once the customers decide how they want to split the bill and choose one of the three aforementioned options, the Application moves onto one of three different Allocation Screens, one for each option. If one payer decides to pay the entire bill, the payer taps the option 1 box, and a new screen appears on the tablet with the amount due to be paid. When the single assigned payer agrees to proceed, the Application moves straight onto the payment screens. If multiple payers decide to split the bill evenly, someone taps the option 2 box. A new screen appears and asks for the number of people at the table. When someone enters a number, a corresponding number of Payer Boxes appear on the screen (see, e.g., FIG. 7). For example, if there are five people at the table, someone enters 5, via the screen keyboard, and five Payer Boxes appear: Payer 1, Payer 2, Payer 3, Payer 4 and Payer 5. Each Payer Box may also display the amount each payer owes if the total bill is equally split, in this case, five ways. For example, if the total bill is $100, each of the five payers will have $20 automatically allocated to their box, the amount they owe. There may also be the option for any individual payer to pay for any another individual payer's share of the bill. To use the previous example, if there are five payers each paying $20 but Payer 1 agrees to pay Payer 2's share, then Payer 1 and Payer 2's boxes can be pinched together, to combine the amounts on the screen so as Payer 1 is now assigned $40 and the Payer 2 box disappears. This functionality works for all payer scenarios and combinations. When all the payers agree to pay their own allocated amounts, the Application moves forward from the Allocation Screen onto the Payment Screens.

If multiple payers decide to split the bill according to what they individually ordered, when someone taps the Option 3 box, a new screen, the same as in option 2, may appear and asks for the number of customers at the table. Again, if there are five people at the table, five boxes may appear numbered Payer 1 to 5 but the amount owed by each player is set at zero. This screen may also displays a sidebar with a scrollable list of the items the table ordered, the number of each item ordered and the total cost associated with each item. This may be information downloaded by the waitperson off the restaurant's POS system. As an example, one line item in the sidebar might say, “3 Hamburgers @ $8 total $24.” In this example, three of the five payers ordered hamburgers as part of their meal. When it comes to their turn, each payer who ordered these hamburgers allocates one of the hamburgers to themselves by dragging and dropping the line item into their own box. The payer's box then registers the one hamburger and the cost. The itemized sidebar list also automatically reduces to display the remaining balance of “2 Hamburgers @$8 total $16.” Either a single designated person or each payer takes their turn to work their way through the itemized sidebar list until everything is allocated to the payer boxes and the sidebar list is empty. Payers can, if they want to, double check by tapping their own boxes to bring up dropdown list of everything allocated to them. If an item needs to return to the sidebar list, it can be dragged and dropped back.

Other options include the allocation of shared items such as starters and bottles of wine that were ordered for the some of or the whole table. The cost of these items can be split across all payers or certain designated payers. Again if there are five payers and the table shared two starters, each costing $10 for a total of $20, these shared items can be double-tapped in the sidebar list and the cost is automatically evenly split five ways with an extra $4 added to each payers' individual total. If the table wants to equally split shared items amongst certain payers but not all payers, instead of double-tapping the item, someone holds down the item for a second or two, then highlights the payers they want to designate an equal share to. For example, if someone ordered an expensive bottle of wine for $60, but two of the five payers did not drink it, someone holds down the bottle of wine line item in the sidebar list, then highlights the three payers who did drink it, the Application then adds $20 ($60 divided by 3) to each of the designated wine-drinkers and nothing to the non wine-drinkers.

In the same way as Option 2, once all the items have been allocated, any payer can pay any other payers' shares by pinching the relevant boxes together to merge the amounts. As in Options 1 and 2, when all payers agree to pay the amounts allocated to them, the Application may move forward onto the next step, the Payment Screens.

The Payment Screens may be the next steps of the payment process. The next steps may include redeeming coupons, tip setting, receipts, payment method choice and payment. The Allocation Screen displays a box for each payer and the amount they owe. Each payer, be it one, five, or as many as there are, now may take their turn to complete their individual part of the payment procedure. Once everyone has worked their way through the Payment screens, the table has paid in full.

The Coupon Screen may be the first payment screen, and it may allow any payers to redeem any relevant discount or special offer coupons they want to use to reduce the total due if they have any, but can skip it if they do not. Coupons come in many forms and the System may redeem them all. The two main types of coupons are percentage discounts on entire meals and special offers such as “buy a cheeseburger, get a free beer.” The main difference between the two types is that a “20% off” type coupon covers all the customers at a table and a “free beer” type coupon only covers the individual payer who holds the coupon. To deal with this, the Coupon Screen may ask the payer who the relevant recipients of the coupon's benefits are before scanning the coupon, Apply to Table? or Apply to Payer? Once the coupon holder has chosen which payers the coupon applies to, the screen may prompt the coupon holder to redeem the coupon.

The Application, working in conjunction with the Attachment's barcode reader, may be designed to read and process barcodes in paper form as well as all other electronic media i.e. those barcodes that are distributed and can be redeemed with the use of smartphones and all other personal communication devices. The Application may also process other “non-barcode” coupons such as coupons with manually entered codes and those that can be scanned and read with a tablet's in-built camera.

The coupon-holder may scan their coupon and it may then be verified wirelessly via the restaurant's existing POS system or other coupon redemption system. The Application may then automatically apply the discount or any other special deal to the bill and adjust the final amount(s) each payer owes. For example, a single payer, using payment Option 1, owes a total $125 and has a coupon offering a 20% discount. The payer redeems the coupon, the System gets it verified and then the Application automatically recalculates the total amount owed down to $100. In the same example but with five different payers, using Option 2, each payer's total owed adjusts down from $25 each to $20 each if equally divided or by whatever the percentage amount of the coupon if option 3 is used. Once each payer's coupon-adjusted split has been calculated, they then take turns to complete their own dedicated part of the payment process. From this point, each payer proceeds individually. The next step may be to set tip levels for the waitperson who served the table.

A Tip Screen may present each payer with the amount they are due to pay for their share of the meal, a predetermined recommended default tip amount based on the amount due, and the total amount due (the meal amount plus recommended tip amount.)

The payer may change the tip percentage level by tapping the tip box to (a) bring up a dropdown menu of alternative higher and lower tip percentage levels, or (b) enter in any amount manually. The total amount due may be automatically recalculated to take into account any tip adjustment. For example, if one payer is paying an entire bill that comes to a $100 and the default tip level is 15% then the total amount due is $115. If the customer changes the tip level to 20% then the total amount due may automatically correct to $120. Or if the default total amount due is $115, the customer can override the default tip level and manually input a tip, for example $22, using the tablet's screen keyboard, and the total amount due could recalculate to $122. The payer may have the ability to set any tip level they feel is appropriate.

The Application also has an option to let a payer round a tip up. For instance, if the meal amount plus the default tip comes to $114.35, the Application asks if the payer would like to round up to the nearest $5 for smaller bills or $10 for larger ones. In this case, the Application asks whether the payer would like to round up from $114.35 to $120. If the payer agrees, the total amount due adjusts accordingly to $120. If there are multiple payers, each payer may set their own tip level in the same way when it comes to their turn to establish how much to pay. All payers, no matter how many there are, once they have set their tip level, may then proceed on to the Receipt Screen.

The Receipt Screen may present each payer with two options: either receive a paper printout with their share of the itemized bill, the total amount charged and the limited card authorization information found on any standard credit card receipt, or receive the same information attached to an email, an “e-receipt” sent to any e-mail address the payer enters when the Application prompts them to furnish it. If the payer selects the paper printout, the Application may send the relevant information to an on-site printer. If the payer selects the e-mail option, the Application may send relevant information to an off-site Database for logging, storing and email sending. After a payer decides how they want to receive their receipt, the Application may move onto the next part of the process, a Final Payment Screen.

The Final Payment Screen may provide each payer with various payment method options including credit cards, debit cards, pre-paid gift cards, cash, and other alternative mobile payment systems. If a payer chooses to pay by debit or credit card, the Application may automatically inform the Attachment the amount to charge the credit/debit card about to be swiped and then prompts the payer to swipe. The payer swipes their card through the Attachment which then sends the card's information and receives the payment authorization either to and from the restaurant's existing POS system if it is connected to the card processing company, or directly to any standalone card processing system the restaurant already uses. Once the Attachment receives authorization, it may then relay it to the Application that then inform the payer that their card payment has been authorized. A blank box may appear on the tablet screen with a prompt asking the payer to sign inside it with a supplied stylus. The virtual signature may be electronically scanned onto the paper or electronic receipt. If the payer's card is declined, the Application may let the payer know that their payment has not gone through and ask for an alternative payment.

In the case of multiple payers, the Application may automatically revert back to the Allocation Page after every completed payment and the box assigned to each payer changes color to indicate that their part of the process has been completed. The Application then prompts the next payers to proceed with their own payment. This process continues until all the payers' blocks have changed color and every payer has paid up.

If a payer chooses the cash payment option, the procedure is even simpler. They enter the amount of cash they are leaving and the Application will calculate and then display the amount paid and the change due back.

As the designated payers work their way through the payment procedures, a sidebar may keep a running tally of the amounts paid, the amount still to be paid, the amount paid by card, the amount paid by cash and the amount of change in cash due back to the table. A sidebar tally may be a useful snapshot for the payers to see what still needs to be paid, and for the waitperson to see how much change needs to be returned to the table once the payment process is complete.

(3) The Database

The Database is the centralized computer server-based or cloud-based depository where customer information is collected and stored, all electronic receipts are sent from and verified, and from where new coupons are distributed. The Database can also be used to help restaurants analyze their own customers' spending habits and produce richer analysis for more targeted marketing strategies and coupon distribution.

If a payer chooses the e-receipt option, as described previously, the System requires an e-mail address to send the e-receipt to. The payer may be asked to manually enter an e-mail address into the Application, and the Application may wirelessly bundle it and send it to the Database with the itemized breakdown of the payer's bill, an electronic copy of their signature, and the card authorization codes. The Database may automatically collect and register the information. If a customer is using the e-receipt system for the first time, a new record may be created. If the payer's e-mail address already exists in the Database (i.e. the payer is a repeat customer), the Database may add the payment information to the existing record.

Once the record has been created or added to, the Database may automatically email the payer an e-receipt with information typically found on payment receipts and card authorization slips, plus a facsimile of the cardholder's signature attached. The e-receipt may be sent in a .pdf format or other format.

The Database may also have a secure internet web portal that allows online e-receipt access and verification. Many customers have no need for receipts and discard them as soon as they leave the establishment or when they clear out their pockets, handbags or wallets. However, receipts are vital to business customers who need them to either claim back expenses from their own company's accounts department or for tax purposes. Since e-receipts can potentially be doctored or even fabricated, each e-receipt may also have a unique verification code referenced to the specific receipt and card authorization information logged in the Database. If a company accountant or the IRS need to verify that a receipt is genuine and accurate, they could go to the website linked to the Database, enter the receipt's unique code, and access a secure copy that can be used to compare details and verify that the receipt is genuine and accurate.

The Database can also play an integral part in a restaurant or restaurant chain's marketing campaign. The Database can help restaurants sort and analyze what their individual and collective customers have ordered historically and search for themes and trends. These themes and trends can then be cross-referenced and used to produce more targeted marketing to encourage customers to return and spend more. The information the Database and analytics provide is the basis for improved coupon distribution. For example, instead of a restaurant or restaurant chains sending out citywide, regional or even national mail shots or newspaper inserts with broad-based coupon initiatives, restaurants can email personalized coupon offers directly to customers based on recommendations derived from analyzing their prior orders. For example, if customer John Smith, having been a payer at a table that had previously used option 3, the “Who Had The Lobster?” option on the Application (i.e. only paid for what he had ordered), the Database would know exactly what he ordered, and therefore can infer from what he ordered what he likes. If he is a repeat customer, then the Database information on John Smith will be deeper and wider (e.g., if he ordered a bacon cheeseburger once, he likes bacon cheeseburgers but if he ordered a bacon cheeseburger twice or three times then he loves bacon cheeseburgers). With this information, a restaurant chain can tailor a special offer specific to John Smith. The Database can then send John Smith a special bacon cheeseburger deal coupon directly to his e-mail address. This will encourage John Smith to come back to the restaurant the next time he is the mood for a bacon cheeseburger. This targeted tailored approach to coupon distribution invariably leads to a greater coupon redemption rate. If a customer receives a coupon that is relevant to their specific tastes they are more likely to return to the establishment, redeem it and spend money on other items.

The System may also be a highly efficient and productive coupon distribution and redemption system that encourages repeat business. When customers visit a restaurant, order and consume a meal, enter their e-mail addresses into the System, pay via the system, and receive e-receipts, then the customers' e-mails and consumption information are logged onto the Database and analyzed, and customers are sent further coupons electronically. These are tailored to individual tastes and encourage repeat business. The customers return to the restaurant and may redeem the coupons by using the Attachment's coupon scanner to read coupon barcodes on their smartphone screens. The customers leave happy in the knowledge that they got a good deal, thus increasing likelihood of further repeat business. At the same time, the restaurant gets more information on the customers' preferences on the Database, thus allowing for even more accurate and targeted coupon marketing in the future, thus repeating the cycle again and again allowing each restaurant or restaurant chain the opportunity to create their own self-contained coupon distribution eco-system.

(4) The Router

The Router may be a wireless router that physically and wirelessly ties the entire System together and connects it to a restaurant's pre-existing POS system and/or standalone card payment processing system. The Router may provide the System with the flexibility to work with any POS system set-up, from small independent restaurants to large, national restaurant chains. It could make the System universally adoptable.

The Router may be physically connected to the restaurant's POS system and/or standalone payment processing system and may be wirelessly connected to the restaurant's tablets. It also may wirelessly connect the System to an off-site centralized Database. The Router connects the various hardware and software components in multiple ways. This flexibility may allow the system to connect and function with any pre-existing POS and card payment processing system set-ups restaurants already use. This flexibility may also allow the whole System to be plugged into any existing POS system, and electronically establish the necessary connections to function, making the whole system “plug and play.” The Router may provide more connectivity options than may be necessary for any one restaurant's pre-existing system but it is this “overkill” that makes the system universal in nature.

The Router may connect to the POS, tablets, the Database, any standalone card payment system, and any standalone coupon system.

The Router may physically connect to a restaurant's POS system with a USB or Ethernet connection. This physical connection's main function would be to get data to and from a restaurant's existing POS system if it has no in-built wireless capability. The Router may receive a tablet's request for a table's billing itemized information, and send the request to the POS system. The POS system may then send the itemized billing information back to the Router which may then send it on to the Application installed on the tablet that originally requested it.

The Router may also receive a tablet's card authorization request, and send the request to the restaurant's POS system if it has an in-built payment processing connection, or directly to the restaurant's standalone processing system if the restaurant has one of these instead. The Router may then receive the card authorization or rejection back from the POS or standalone processing system and send it back to the tablet that originally requested it.

The Router may also receive all coupon verification requests wirelessly from the tablets (either via the Application or directly from the Attachment), and relays these requests to either the restaurant's POS system or any standalone coupon system the restaurant may have. The Router may then receive the coupon verification back from the POS system or the standalone system and relay it back to the tablet's Application.

The Router may also wirelessly connect the entire system to the off-site centralized Database. The Router receives all e-mail addresses and scanned electronic signatures from restaurant customers who submit them on the tablet's Application in order to receive an e-receipt. The Router bundles the e-mail and signature information with the customer's card authorization and itemized billing data from the POS and sends it all to the Database for logging and e-receipt distribution.

The System may be designed to be completely adaptable and updateable to any present & future technical and technological advances and innovations. When other mobile payment methods and security systems such as chip and pin, camera recognition, and biometrics become more mainstream, updating the tablets, updating the Attachment and rewriting the Application can bring the entire system in line with any and all technological advances.

Although certain preferred exemplary embodiments of the present invention have been shown and described in detail, it should be understood that various changes and modifications may be made therein without departing from the scope of the appended claims.

1. A bill calculation and payment system, comprising:
(a) a router;
(b) a computer server in network communication with the router and having a database;
(c) a computer tablet having a communication port, said tablet in network communication with the router;
(d) an attachment unit having a card scanner and electrically connected to the communication port of the tablet, and;
(e) an application program installed on the tablet, said application program adapted to display an itemized bill, allow the selection of a payment amount, allow the selection of a payment method, transmit payment information to the router, and receive payment authorization information from the router.
